(19) United States
(12) Patent Application Publication
(10) Pub. No.: US 2009/0313823 A1
(43) Pub. Date: Dec. 24, 2009

(54) IMPARTING DEEP COMPRESSIVE RESIDUAL STRESSES INTO A GAS TURBINE ENGINE AIRFOIL PERIPHERAL REPAIR WELDMENT

(76) Inventors: Todd Jay Rockstroh, Maineville, OH (US); Seetha Ramaiah Mannava, Cincinnati, OH (US); Roger Owen Barbe, Cincinnati, OH (US)

Correspondence Address: Steven J. Rosen;Patent Attorney, 4729 Cornell Rd., Cincinnati, OH, 45241, US

(21) Appl. No.: 12/144,940

(22) Filed: Jun. 24, 2008

(51) Int. Cl. B23P 6/00

(52) U.S. Cl. 29/889.1

(57) ABSTRACT

A gas turbine engine airfoil is repaired by machining away airfoil material along at least a portion of at least one of leading and trailing edges and a radially outer tip forming at least one cut-back area and forming a weldment by welding successive beads of welding material into the cut-back area. Desired finished dimensions of the repaired airfoil are obtained by machining away some of the weld bead material in the weldment and then deep compressive residual stresses are imparted in a pre-stressed region extending into and encompassing the weldment and a portion of the airfoil adjacent the weldment. The compressive residual stresses may be are imparted after either rough machining or final finishing thereafter of the weldment. The cut-back area may extend up to about 90% of the airfoil's span and have a maximum cut-back depth up to about 0.22 inches.

### BACKGROUND OF THE INVENTION

### Field of the Invention

This invention relates to gas turbine engine airfoil edge repair and, in particular, cutting out a damaged area and welding in beads of material to build up airfoil leading and trailing edges and tips.

Gas turbine engines include fan, compressor, combustion, and turbine sections. Disposed within the fan, compressor, and turbine sections are alternating annular stages of circumferentially disposed moving blades and stationary vanes having airfoils with leading and trailing edges and radially outer tips subject to wear and tear. The rows or stages of vanes and blades are concentrically located about a centerline axis of the gas turbine engine. The blades are typically mounted on a disk which rotates about its central axis and integrally formed disks and blades referred to as BLISKS have been used in many aircraft gas turbine engines.

Fan and compressor blades are typically forged from superalloys such as a nickel-base alloy while turbine blades typically are made from high temperature alloys or superalloys containing titanium. In addition, the casting of turbine vanes and blades is frequently performed so as to produce a directionally solidified part, with grains aligned parallel to the axis of the blade or a single crystal part, with no grain boundaries. More recently, ceramic matrix composite and metal matrix composite materials have been used to make solid and hollow gas turbine engine blades and vanes.

In service, damage and deterioration of leading and trailing edges and tip of the compressor blade occurs due to oxidation, thermal fatigue cracking and metal erosion caused by abrasives and corrosives in the flowing gas stream as well as high cycle fatigue (HCF). During periodic engine overhauls, the blades are inspected for physical damage and measurements are made to determine the degree of deterioration and damage. If the blades have lost substantial material, then they are replaced or repaired.

Several methods exist for repairing the worn or damaged turbine blades and vanes. Repair methods include, for example, conventional fusion welding, plasma spray as described in U.S. Pat. No. 4,878,953, and the use of a tape or slurry material containing a mixture of a binder and a metal alloy powder which is compatible with the substrate alloy. U.S. Pat. No. 4,878,953 provides an excellent source of background information related to methods for refurbishing cast gas turbine engine components and, particularly, for components made with nickel-base and cobalt-base superalloys for use in the hot sections of gas turbine engines and, more particularly, for components exposed to high temperature operating conditions. U.S. Pat. No. 4,726,104, entitled “Methods for Weld Repairing Hollow, Air Cooled Turbine Blades and Vanes” discloses prior art methods for weld repairs of air cooled turbine blade tips including squealer tips.

Some gas turbine engine compressor blades are designed so that, during engine operation, the tip portion of the rotating blades rubs a stationary seal or casing, and limits the leakage of working medium gases in the axial flow direction. While the seals are usually more abradable than are the blade tips (so that during such rub interactions, a groove is cut into the seal), the blade tips do wear, and the blades become shorter. As the blades accumulate service time, the total tip wear increases to the point that eventually, the efficiency of the blade and seal system is reduced and cracks may appear in the blades especially at the blade tips such that the blades need to be repaired or replaced. Repairing is much cheaper and more desirable.

The leading and trailing edges and tips of worn blades can be repaired and the airfoils restored to original dimensions by mechanically removing, such as by cutting out or grinding down, the worn and/or damaged areas along the leading and trailing edges and tip of the damaged airfoil and then adding weld filler metal to the tip to build up the leading and trailing edges and tip to a desired dimension using any of several well known welding techniques (typically arc welding techniques) known to those skilled in the art. When an engine is overhauled, compressor blades are either replaced by new parts, which is very expensive, or repaired, which is clearly more desirable if a cost savings may be achieved. Several methods have been devised in which a metal overlay is deposited by spraying or welding metal metallic filler in successive beads onto a substrate to form or dimensionally restore gas turbine engine compressor blade airfoils and, more particularly, the blade's leading and trailing edges and tip. A key limitation to weld repairs is that the repaired parts have a derated life from OEM specs.

Repairing and restoring leading and trailing edges and tip of airfoils by welding causes the airfoil to have a high cycle fatigue HCF capability that is much less than the original equipment manufacturing (OEM) or new part capability. The amount of airfoil that can be repaired and restored by this method is limited because welding causes reduced high cycle fatigue HCF capability. It is highly desirable to repair or restore the leading and trailing edges and tip of airfoils by welding and yet still have a high cycle fatigue HCF capability that as good or nearly as good as that of the original or new part. It is highly desirable to repair or restore a greater amount of the airfoil by welding and yet still have a high cycle fatigue HCF capability that as good or nearly as good as that of the original or new part.

### BRIEF DESCRIPTION OF THE INVENTION

A method of repairing a gas turbine engine airfoil having a periphery that includes leading and trailing edges and a radially outer tip includes machining away airfoil material along at least a portion of the periphery to form at least one cut-back area in the airfoil along at least a portion of at least one of the edges and/or the radially outer tip of the airfoil. Then forming a weldment in the cut-back area by welding successive beads of welding material into the cut-back area beginning with a first bead on a welding surface of the airfoil along the cut-back area and then machining away some of the weld bead material in the weldment to obtain desired finished dimensions of at least one of the edges and/or the radially outer tip of the airfoil. Then imparting deep compressive residual stresses in a pre-stressed region extending into and encompassing the weldment and a portion of the airfoil adjacent the weldment.

An exemplary embodiment of the method further includes machining away airfoil material along only radially outermost portions of the leading and/or trailing edges extending from the outer tip towards a base of the airfoil. This embodiment of the method further includes forming a rounded corner having a semi-circular corner, with an arc and radius of curvature, between the leading edge and/or trailing edge cut-backs and unmachined portions of the airfoil between the outermost portions of the leading and/or trailing edges and the base of the airfoil. A more particular embodiment of the method includes the outermost portions of the leading and/or trailing edges having a spanwise length up to and including about 90% of a span of the airfoil from the outer tip towards the base of the airfoil. The cut-back area may have a maximum cut-back depth up to about 0.22 inches.

The machining away some of the weld bead material in the weldment to obtain desired finished dimensions of at least one of the leading and trailing edges and the radially outer tip of the airfoil may include rough machining and then final finishing of the weldment and the imparting of the deep compressive residual stresses may be performed after the rough machining or after the final finishing of the weldment.

Another exemplary embodiment of the method further includes laser shock peening to impart the deep compressive residual stresses in a pre-stressed region extending into and encompassing the weldment. This exemplary embodiment of the method includes laser shock peening pressure and suction sides of the airfoil and the portion of the airfoil adjacent the weldment.

Another more particular embodiment of the method includes setting a repaired life of a component containing the repaired gas turbine engine airfoil to substantially at or exceeding a new OEM life of the component.

A repaired gas turbine engine airfoil includes the periphery including leading and trailing edges and a radially outer tip, at least one cut-back area in at least a portion of the periphery, the cut-back area being along at least a portion of at least one of the edges and/or the radially outer tip of the airfoil, a weldment including successive beads of welding material in the cut-back area having a first bead on a welding surface of the airfoil along the cut-back area, and deep compressive residual stresses imparted in a pre-stressed region extending into and encompassing the weldment and a portion of the airfoil adjacent the weldment.

A more particular embodiment of the repaired airfoil includes the cut-back area being along at least one of the leading or trailing edges in a radially outermost portion of the leading and/or trailing edges respectively and extending from the outer tip towards a base of the airfoil. The outermost portion of the leading or trailing edges has a spanwise length up to and including about 90% of a span of the airfoil from the outer tip towards the base of the airfoil. A rounded corner is disposed between the leading edge and/or trailing edge cut-backs and unmachined portions of the airfoil between the outermost portions of the leading and/or trailing edges and the base of the airfoil. The rounded corner may be a semi-circular corner having an arc and radius of curvature. The cut-back area may have a maximum cut-back depth up to about 0.22 inches.

A greater degree of damage and/or wear of the leading and trailing edges and tip of compressor blades may be repaired with the present method instead of more expensive replacement of the blades or prior methods of using weldments without imparting compressive residual stresses. The present repair method including imparting deep compressive residual stresses into and encompassing the weldment and a portion of the airfoil adjacent the weldment provides a comprehensive repair process that can more economically repair and dimensionally restore the edges and tips for far greater damaged airfoils.

### BRIEF DESCRIPTION OF THE DRAWINGS

The foregoing aspects and other features of the invention are explained in the following description, taken in connection with the accompanying drawings where:

FIG. 1 is a perspective view illustration of an exemplary aircraft gas turbine engine compressor blade illustrating wear and/or damage along a leading edge and laser shock peening a repair weldment in the airfoil leading edge and tip.

FIG. 2 is a cross-sectional view illustration of the blade through 2-2 illustrated in FIG. 1.

FIG. 3 is a side view schematic illustration of a first weld bead of the weldment being applied to the blade in FIG. 1 after cut-backs have been machined.

FIG. 4 is a side view schematic illustration of a completed weldment in the blade illustrated in FIG. 3.

FIG. 5 is a side view schematic illustration of comparing an increase in leading edge cut-backs with and without laser shock peened weldment in the blade illustrated in FIG. 4.

FIG. 6 is a side view schematic illustration of a laser shock peened weldment in the blade illustrated in FIG. 4.

FIG. 7 is a perspective view illustration of another exemplary aircraft gas turbine engine compressor blade illustrating wear and/or damage along leading and trailing edges and tip of the blade and dimensional restoration and repair parameters used in an exemplary embodiment of the present invention.

FIG. 8 is a side view illustration of the blade in FIG. 7 with short and long leading and trailing edge and cut-backs and shallow and deep tip cut-backs that may be machined into the airfoil illustrated in FIG. 7.

FIG. 9 is a side view illustration of rounded corners of leading edge cut-back illustrated in FIG. 8.

FIG. 10 is a side view illustration of the beads of the weldment in the short leading and trailing edge and cut-backs and shallow tip cut-backs in the blade illustrated in FIG. 8.

FIG. 11 is a side view illustration of the beads of the weldment in the long leading and trailing edge and cut-backs and deep tip cut-backs in the blade illustrated in FIG. 8.

### DETAILED DESCRIPTION OF THE INVENTION

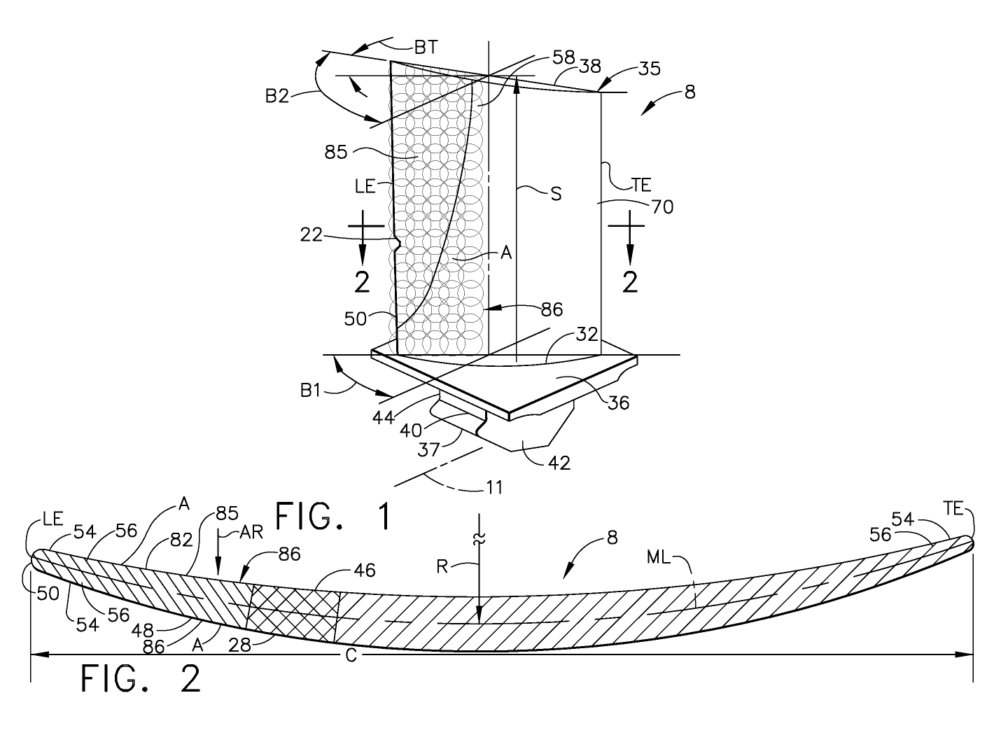

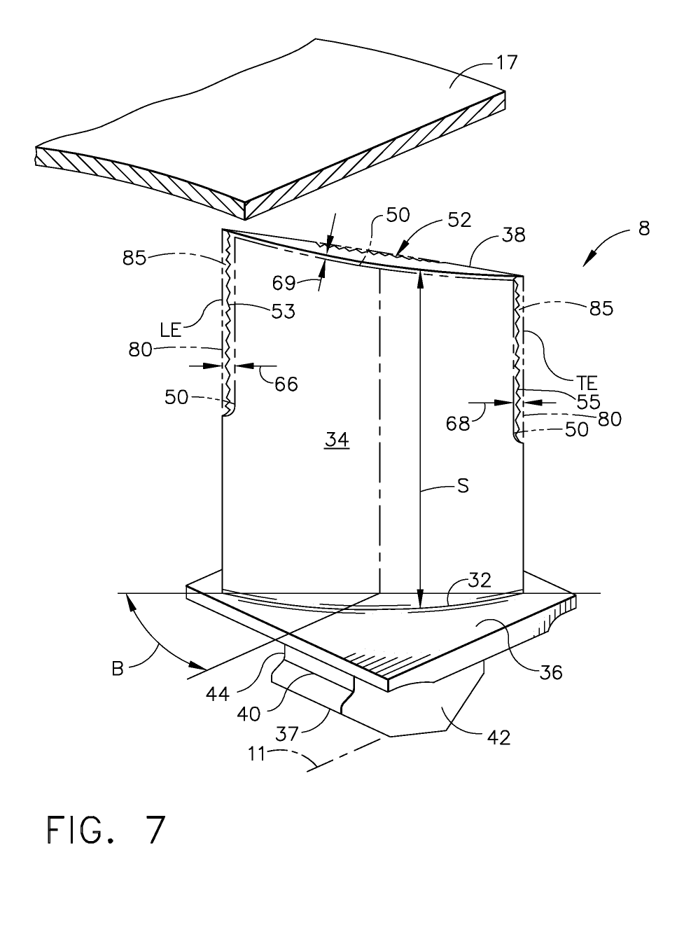

Illustrated in FIGS. 1 and 2 is a compressor blade 8 exemplifying a rotor component such as a fan blade or blisk with an airfoil 34 which is typically circumscribed by a compressor casing 17, shroud, or seal against which the blades seal (such as is illustrated in FIG. 7). The airfoil 34 extends radially outward from an airfoil base 32 located at a blade platform 36 to a blade or airfoil radially outer tip 38 as measured along a span S of the airfoil 34. The compressor blade 8 includes a root section 40 extending radially inward from the blade platform 36 to a radially inward end 37 of the root section 40. A blade root or dovetail 42 is connected by a blade shank 44 to the blade platform 36 at the radially inward end 37 of the root section 40. The compressor blade 8 is representative of class of gas turbine engine components having airfoils and, more particularly, to blades such as fan, compressor, and turbine blades for which the repair method disclosed herein was developed. The repair method disclosed herein may also be applied to stationary vanes in fan, compressor, and turbine sections of a gas turbine engine.

Referring to FIG. 2, a chord C of the airfoil 34 is the line between a leading edge LE and a trailing edge TE at each cross section of the blade. The airfoil 34 extends in the chordwise direction between a leading edge LE and a trailing edge TE of the airfoil. A periphery 35 illustrated in FIGS. 1 and 3-11 of the airfoil 34 is defined by and includes the leading edge LE, the airfoil outer tip 38, and the trailing edge TE. Illustrated in FIG. 2 are pressure and suction sides 46, 48 of the airfoil 34 with the suction side 48 facing in a general direction of rotation as indicated by arrow AR. A mean-line ML is generally disposed midway between the two sides in the chordwise direction. Referring to FIG. 1, often the airfoil 34 has a twist whereby a chord angle B varies from the blade platform 36 to the airfoil outer tip 38. The chord angle B is defined as the angle of the chord C with respect to the engine centerline 11. The chord angle varies from a first angle B1 at the platform 36 to a second angle B2 at the tip 38 for which the difference is shown by an angle differential BT. The chord angle is defined as the angle of the chord C with respect to the engine centerline 11.

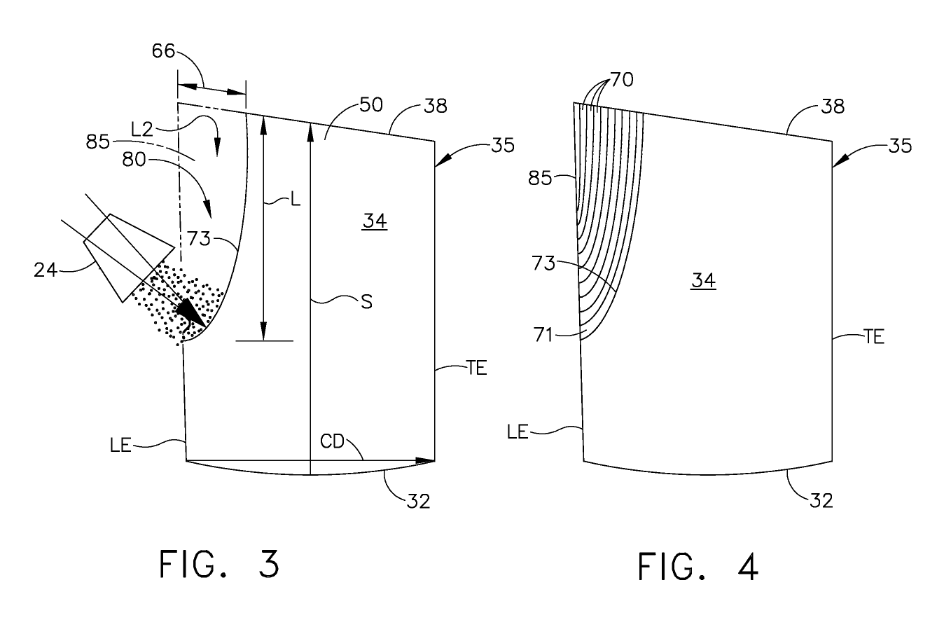

A first exemplary embodiment of the repair method disclosed herein is illustrated in FIGS. 1-6, and described herein for a leading edge repair due to leading edge damage exemplified by a nick 22 in the leading edge LE of the airfoil 34. The repair method includes machining away airfoil material 50 as illustrated in FIG. 3 forming a cut-back area 80 along the leading edge LE and extending a length L in the spanwise direction of the airfoil 34 from the radially outer tip 38 of the airfoil 34 towards the airfoil base 32. The cut-back area 80 has a maximum cut-back depth 66 as illustrated in FIG. 3 as measured in a chordal direction CD from the original unworn and undamaged leading edge LE as illustrated in FIGS. 1 and 3. The machined away airfoil material 50 includes the portions of the airfoil 34 containing the leading edge damage as represented by the nick 22. Next a welding machine 24 is used to weld in a weldment 82 in the cut-back area 80 as further illustrated in FIG. 4.

After the airfoil material 50 is machined away weld beads 70 beginning with a first bead 71 on a welding surface 73 of the airfoil along the cut-back area 80, are welded into the cut-back area 80 forming the weldment 82 therein. Typically, airfoil material 50 is removed along only a radially outer half 28 of the airfoil 34, however, in the repair method presented herein, the removal and the cut-back area 80 may extend downwardly to about 90% of the span S from the airfoil outer tip 38 toward the base 32. Then the weldment 82 is machined to near net shape and then finished to final dimensions and surface smoothness.

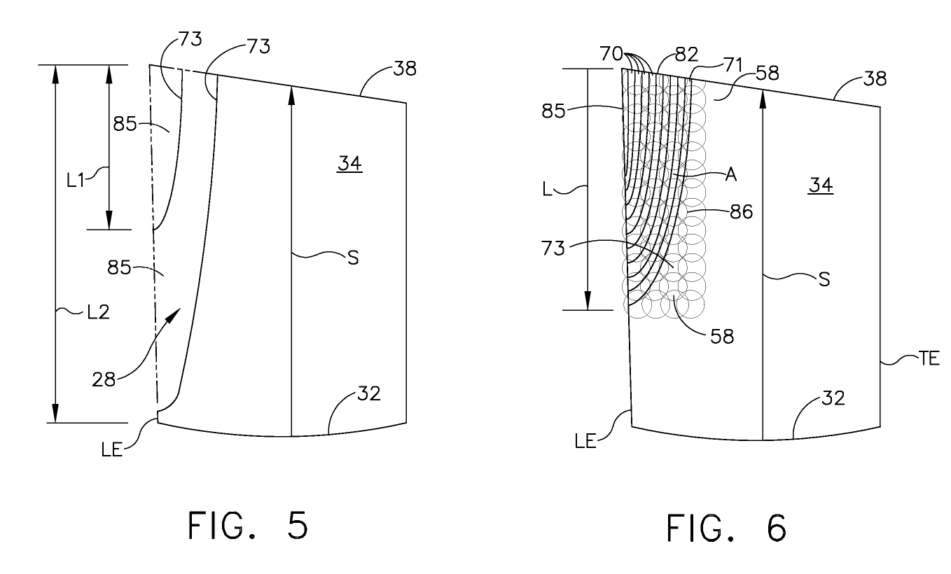

After the weldment 82 is machined to near net shape or after the weldment 82 is finished to final dimensions and surface smoothness deep compressive residual stresses are imparted in pre-stressed regions 56 extending into and encompassing the weldment 82 and a portion 26 of the airfoil adjacent the weldment 82. Imparting the deep compressive residual stresses in pre-stressed regions 56 is illustrated in the figures as being performed by laser shock peening as indicated by circular spots 58 in FIGS. 1 and 6, however other methods are contemplated such as burnishing. The imparting of deep compressive residual stresses into the weldment allows an extension of maximum permitted spanwise length SL of the cut-back area 80 along the leading edge LE (and trailing edge TE) from about 50% as indicated by a first length L1 to about 90% as indicated by a second length L2 illustrated in FIG. 5.

The imparting of deep compressive residual stresses into the weldment allows an extension of permitted maximum cut-back depth 66 to be increased to about 0.2 inches or in a range of 0.18 to 0.22 inches as compared to previous repair methods that allowed only about 0.08 to 0.12 inches from new part dimensions of the leading and trailing edges. Though not drawn to scale, this is illustrated in FIG. 5. Note that there are high pressure compressor airfoils are on the order 0.5 inches in chord and span. The repair method presented above is exemplified for a leading edge repair of gas turbine engine compressor blade airfoil and may be equally applied to repair worn and/or damaged and trailing edges.

The repair method presented herein is also exemplified for gas turbine engine airfoils 34 with worn and/or damaged leading and trailing edges and tip. The repair method is a comprehensive process for restoring the leading and trailing edges and tip of the blade either individually or in combination. Occasionally, but repeatably, the compressor blade 8 rubs on the compressor casing 17 or shroud causing tip damage 52, including burrs, nicks, and tears, on the airfoil outer tip 38 as illustrated in FIG. 7. Wear and FOD damage result in leading and trailing edge damage 53, 55 on the leading and trailing edges LE, TE, respectively, and also include burrs, nicks, and tears. A comprehensive process for repairing or restoring the leading and trailing edges and tip of an airfoil has been developed an is disclosed in U.S. Pat. No. 6,532,656 to Wilkins, et al. issued Mar. 18, 2003 and incorporated herein by reference. The repair of the airfoil and the leading and trailing edges and tip of the airfoil may be done either individually or in combination.

The periphery 35 of the airfoil 34 is defined by and includes the leading edge LE, the airfoil outer tip 38, and the trailing edge TE. The process is typically preceded by an inspection of the airfoil 34 to determine repairability. After the blade 8 is found to have met repairability requirements, the blade is cleaned and prepped for repair.

Referring to FIG. 7, the repair method includes machining away airfoil material 50 along outermost portions 85 of the leading and trailing edges LE and TE and a radially outer tip 38 of the airfoil 34 to form leading edge, trailing edge, and tip cut-backs 62, 63, 64 having leading edge, trailing edge, and tip cut-back depths 66, 68, 69, respectively, of the leading and trailing edges and radially outer tip as illustrated in FIG. 8. The leading edge, trailing edge, and tip cut-back depths 66, 68, 69 are measured from the original unworn and undamaged leading and trailing edges LE, TE and radially outer tip 38 as illustrated in FIGS. 7 and 8. The machined away airfoil material 50 includes the portions of the airfoil 34 containing the tip damage 52, and the leading and trailing edge damage 53, 55.

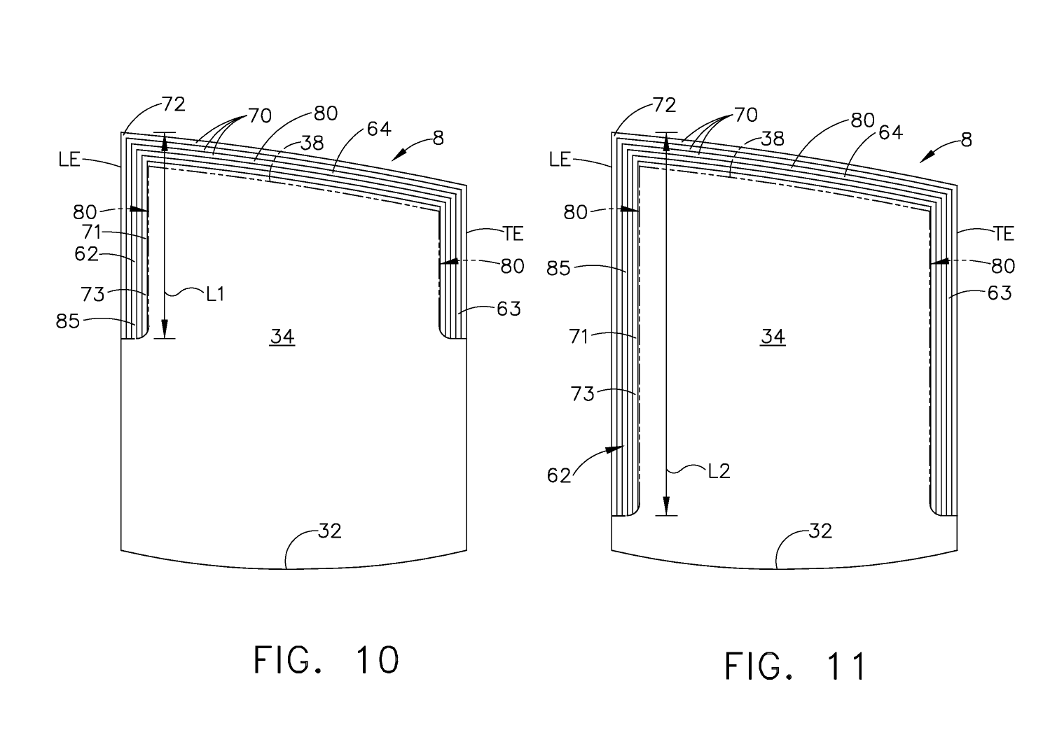

After the airfoil material 50 is machined away weld beads 70, beginning with a first bead 71 on a welding surface 73 of the airfoil along the cut-back area 80 of the leading edge, trailing edge, and tip cut-backs 62, 63, 64, are welded into the cut-back area 80 forming a weldment 82 therein as illustrated in FIGS. 10 and 11. Typically in the past, airfoil material 50 is removed along only a radially outer half 28 of the airfoil 34, however, in the repair method presented herein, the removal and the cut-back area 80 may extend downwardly up to about 90% of the span S from the airfoil outer tip 38 toward the base 32. Then the weldment 82 is machined to near net shape and then finished to final dimensions and surface smoothness. The imparting of deep compressive residual stresses into the weldment allows an extension of previously maximum permitted spanwise length SL of the cut-back area 80 along the leading and trailing edges LE, TE from about 50% as indicated by a first length L1 to about 90% as indicated by a second length L2 illustrated in FIGS. 10 and 11.

Referring to FIGS. 10 and 11, after the airfoil material 50 has been machined away, beads 70 of welding material 72 are welded onto the leading edge, trailing edge, and tip cutbacks 62, 63, 64. Then some of the welding material 72 is machined away to obtain desired finished or restored dimensions of the leading and trailing edges and radially outer tip 38 as illustrated in FIGS. 10 and 11. Exemplary airfoil materials 50 include A-286, Inconel 718, Titanium 6-4, and Titanium 8-1-1. AMS 5832 or Inconel 718 weld wire is an exemplary welding material 72 which can be used with both of these airfoil materials.

Compressor and fan blades repaired in this manner using these conventional welding techniques which include TIG (tungsten inert gas) and microTIG can cause defects in and around the welded areas either in the form of porosities and/or microstructural changes. These defects can reduce material fatigue strength. The leading edge of fan and compressor airfoils have a high level of rotational and dynamic stresses. A high pressure compressor (HPC) airfoil is a component doing work on a fluid and there is a very high level of axial stress distributed differentially between the pressure and suction walls of the airfoil. The HPC airfoil, as well as other airfoils in the gas turbine engine, is also subjected to structural damage from solid particles other than the intended fluid flowing across, around and generally into the leading edge of the airfoil. The stress may be due to excitations of the blade in bending and torsional flexure modes. The dominant failure mode may not always be the maximum stress mode but rather a lower stress mode or combination of modes that exist for longer durations over the engine's mission. During engine operation, compressor and fan blades are subject to centrifugal force, aerodynamic force, and vibratory stimuli due to the rotation of the fan and compressor blades over the various operating speeds of the engine. The airfoils of the blades have various modes of resonant vibration (flexure modes) due to the various excitation forces occurring during engine operation. Blades are basically cantilevered from rotor disks and, therefore, may bend or flex generally in the circumferential direction in fundamental and higher order modes of flexure or flex. Airfoils are also subject to fundamental and higher order torsional modes of vibration which occur by twisting around the airfoil span axis. The flex and torsion modes of vibration may also be coupled together further decreasing the life of the blades. To counter these effects on repaired airfoils, the repair method disclosed herein laser shock peens the pressure and suction sides 46, 48 of the airfoil 34 to form laser shock peened patches 86 over the weldment 82 on both the pressure and suction sides 46, 48 of the airfoil 34 either after the near net shape machining step or after the finishing step of after the weldment 82 is welded in. The laser shock peened patches 86 should extend beyond/over the weldment 82 on both the pressure and suction sides 46, 48 of the airfoil 34 as illustrated in FIGS. 1 and 3.

In the exemplary embodiment of the disclosed repair method, the airfoil material 50 along only radially outermost portions 85 of the leading and trailing edges LE, TE extending from the outer tip 38 towards the base of the airfoil is machined away. In previous repair methods, airfoil material along only a radially outer half 28 of the airfoil 34 is machined away, but in the present method with laser shock peening of the weldment, the leading edge and trailing edge cut-backs 62, 63 may extend up to about 90% of the span along the leading and trailing edges.

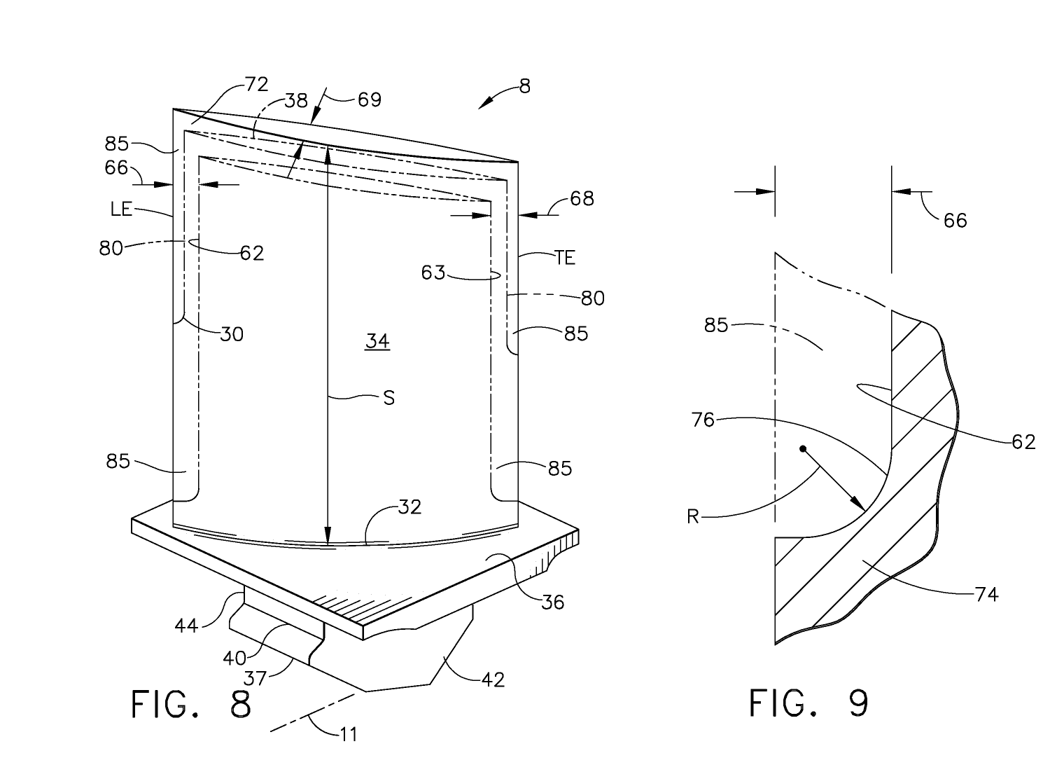

As further illustrated in FIG. 9, a fillet or rounded corner 30 is formed between the leading edge and trailing edge cut-backs 62, 63 and unmachined portions 74 of airfoil 34 between the outermost portions 85 of the leading and trailing edges LE, TE and the base 32 of the airfoil 34. In the exemplary embodiment, the rounded corner 30 is a semi-circular corner having an arc 76 and radius of curvature R. The outermost portions 85 of the leading and trailing edges that are machined away may extend up to about 90% of a span S of the airfoil 34 from the outer tip 38 towards the base 32 of the airfoil. Previous repair methods without laser shock peening have only allowed the outermost portions 85 to extended about 50% of the span S. The leading edge and trailing edge cut-backs 62, 63 have a maximum cut-back depth 66 as illustrated in FIG. 3 as measured from the original unworn and undamaged leading edge LE as illustrated in FIGS. 1 and 3. The laser shock peening of the weldment allows the maximum cut-back depth 66 to be increased to about 0.2 inches or in a range of 0.18 to 0.22 inches as compared to non laser shock peening repair methods that allowed only about 0.08 to 0.12 inches from new part dimensions of the leading and trailing edges. The imparting of deep compressive residual stresses into the weldment allows an extension of previously maximum permitted spanwise length SL of the cut-back area 80 along the leading and trailing edges LE, TE from about 50% as indicated by a first length L1 to about 90% as indicated by a second length L2 illustrated in FIGS. 10 and 11.

The weldment 82 is machined away to obtain the desired finished dimensions of the leading and trailing edges and radially outer tip by rough and then final blending or finishing of the weldment 82. During the rough machining, the weldment 82 is machined to near net shape and then finished to final dimensions and surface smoothness. Desired finished dimensions of the airfoil's leading edge LE and the airfoil outer tip 38, particularly along the weldment 82, is obtained by contouring of the leading edge LE. Welding parameters and cut-back depths are controlled to prevent airfoil deformation that would require further cold processing to qualify the airfoil for use. The weld beads may be applied with an automated plasma-arc weld process along the cut-back leading and trailing edges and radially outer tip. A Liburdi Laws 500 welding center is one suitable apparatus for the process.

The weldment 82 is subject to loss of high cycle fatigue capability and, thus, the present method includes laser shock peening (LSP) the pressure and suction sides 46, 48 of the airfoil 34 in areas A that entirely encompass the weldment 82. The laser shock peened patches 86 include laser shock peened surfaces 54 formed in the areas A and pre-stressed region 56 having deep compressive residual stresses imparted by laser shock peening (LSP) extending into the airfoil 34 from the laser shock peened surfaces 54. The pre-stressed regions 56 extend beyond the weldment 82 and the leading edge cut-back 62 into the airfoil 34. The laser shock peening may be performed either after the rough or near net machining of the welding material 72 to obtain the near net shape or after final blending or surface finishing to restore the final dimensions of the leading edge LE and the radially outer tip 38. The entire laser shock peened surface 54 is formed by overlapping laser shocked peened circular spots 58.

The laser shock peening induces deep compressive residual stresses in compressive pre-stressed regions 56. The compressive residual stresses are generally about 50-150 KPSI (Kilo Pounds per Square Inch) extending from the laser shocked peened surfaces 54 to a depth of about 20-50 mils into laser shock induced pre-stressed regions 56. The deep compressive residual stresses may also be induced by other cold working methods such as burnishing.

The laser beam shock induced deep compressive residual stresses are produced by repetitively firing a high energy laser beam that is focused on a surface which is covered with paint to create peak power densities having an order of magnitude of a gigawatt/cm.sup.2. The laser beam may be fired through a curtain of flowing water over the laser shock peened surface 54 which is usually painted or otherwise covered with an ablative material and the ablative material is ablated generating plasma which results in shock waves on the surface of the material. These shock waves are re-directed towards the painted surface by the curtain of flowing water to generate travelling shock waves (pressure waves) in the material below the painted surface. The amplitude and quantity of these shockwave determine the depth and intensity of compressive stresses. The ablative material is used to protect the target surface and also to generate plasma but uncoated surfaces may also be laser shock peened. Ablated material is washed out by the curtain of flowing water.

Laser shock peening the weldment in a repaired airfoil as disclosed herein can physically make the airfoil “as good as new”. A key limitation to more conventional weld repairs is that the repaired parts have a derated life from original equipment manufacturer (OEM) specifications. The laser shock peening of the repair weldment as disclosed herein appears to improve and completely overcome the weld debit of the rated life of the repaired component with the weldment in the repaired airfoil. The laser shock peening of the repair weldment may be applied to an airfoil that was originally laser shock peened along the leading and/or trailing edges and/or tip.

While there have been described herein what are considered to be preferred and exemplary embodiments of the present invention, other modifications of the invention shall be apparent to those skilled in the art from the teachings herein and, it is therefore, desired to be secured in the appended claims all such modifications as fall within the true spirit and scope of the invention. Accordingly, what is desired to be secured by Letters Patent of the United States is the invention as defined and differentiated in the following claims.

What is claimed is:

1. A method of repairing a gas turbine engine airfoil having a periphery that includes leading and trailing edges and a radially outer tip, the method comprising the steps of:
machining away airfoil material along at least a portion of the periphery to form at least one cut-back area in the airfoil,
the cut-back area being along at least a portion of at least one of the edges and/or the outer tip of the airfoil,
forming a weldment in the cut-back area by welding successive beads of welding material into the cut-back area beginning with a first bead on a welding surface of the airfoil along the cut-back area,
machining away some of the weld bead material in the weldment to obtain desired finished dimensions of at least one of the edges and/or the outer tip of the airfoil, and
imparting deep compressive residual stresses in a pre-stressed region extending into and encompassing the weldment and a portion of the airfoil adjacent the weldment.

2. A method as claimed in claim 1, further comprising the machining away airfoil material along the leading and/or trailing edges including machining away airfoil material along only radially outermost portions of the leading and/or trailing edges extending from the outer tip towards a base of the airfoil.

3. A method as claimed in claim 2, further comprising the outermost portions of the leading and/or trailing edges having a spanwise length up to and including about 90% of a span of the airfoil from the outer tip towards the base of the airfoil.

4. A method as claimed in claim 3, further comprising the machining away airfoil material along the leading and/or trailing edges including forming a rounded corner between the leading edge and/or trailing edge cut-backs and unmachined portions of the airfoil between the outermost portions of the leading and/or trailing edges and the base of the airfoil.

5. A method as claimed in claim 4, further comprising the rounded corner being a semi-circular corner having an arc and radius of curvature.

6. A method as claimed in claim 1, further comprising the cut-back area having a maximum cut-back depth up to about 0.22 inches.

7. A method as claimed in claim 6, further comprising the machining away airfoil material along the leading and/or trailing edges including machining away airfoil material along only radially outermost portions of the leading and/or trailing edges extending from the outer tip towards a base of the airfoil.

8. A method as claimed in claim 7, further comprising the outermost portions of the leading and/or trailing edges having a spanwise length up to and including about 90% of a span of the airfoil from the outer tip towards the base of the airfoil.

9. A method as claimed in claim 8, further comprising the machining away airfoil material along the leading and/or trailing edges including forming a rounded corner between the leading edge and trailing edge cut-backs and unmachined portions of the airfoil between the outermost portions of the leading and/or trailing edges and the base of the airfoil.

10. A method as claimed in claim 9, further comprising the rounded corner being a semi-circular corner having an arc and radius of curvature.

11. A method as claimed in claim 1, further comprising the machining away some of the weld bead material in the weldment to obtain desired finished dimensions of at least one of the leading and trailing edges and the outer tip of the airfoil including rough machining and then final finishing of the weldment.

12. A method as claimed in claim 11, further comprising imparting the deep compressive residual stresses after the rough machining or after the final finishing of the weldment.

13. A method as claimed in claim 12, further comprising the machining away airfoil material along the leading and/or trailing edges including machining away airfoil material along only radially outermost portions of the leading and/or trailing edges extending from the outer tip towards a base of the airfoil.

14. A method as claimed in claim 13, further comprising the outermost portions of the leading and/or trailing edges having a spanwise length up to and including about 90% of a span of the airfoil from the outer tip towards the base of the airfoil.

15. A method as claimed in claim 14, further comprising the machining away airfoil material along the leading and/or trailing edges including forming a rounded corner between the leading edge and/or trailing edge cut-backs and unmachined portions of the airfoil between the outermost portions of the leading and/or trailing edges and the base of the airfoil.

16. A method as claimed in claim 15, further comprising the rounded corner being a semi-circular corner having an arc and radius of curvature.

17. A method as claimed in claim 12, further comprising the cut-back area having a maximum cut-back depth up to about 0.22 inches.

18. A method as claimed in claim 17, further comprising the machining away airfoil material along the leading and/or trailing edges including machining away airfoil material along only radially outermost portions of the leading and/or trailing edges extending from the outer tip towards a base of the airfoil.

19. A method as claimed in claim 18, further comprising the outermost portions of the leading and/or trailing edges having a spanwise length up to and including about 90% of a span of the airfoil from the outer tip towards the base of the airfoil.

20. A method as claimed in claim 19, further comprising the machining away airfoil material along the leading and trailing edges including forming a rounded corner between the leading edge and/or trailing edge cut-backs and unmachined portions of the airfoil between the outermost portions of the leading and/or trailing edges and the base of the airfoil.

21. A method as claimed in claim 20, further comprising the rounded corner being a semi-circular corner having an arc and radius of curvature.

22. A method as claimed in claim 1, further comprising the imparting deep compressive residual stresses in a pre-stressed region extending into and encompassing the weldment including laser shock peening the weldment.

23. A method as claimed in claim 22, further comprising the laser shock peening the weldment including laser shock peening pressure and suction sides of the airfoil.

24. A method as claimed in claim 23, further comprising the laser shock peening the weldment including laser shock peening the portion of the airfoil adjacent the weldment.

25. A method as claimed in claim 24, further comprising the machining away airfoil material along the leading and/or trailing edges including machining away airfoil material along only radially outermost portions of the leading and/or trailing edges extending from the outer tip towards a base of the airfoil.

26. A method as claimed in claim 25, further comprising the outermost portions of the leading and/or trailing edges having a spanwise length up to and including about 90% of a span of the airfoil from the outer tip towards the base of the airfoil.

27. A method as claimed in claim 26, further comprising the machining away airfoil material along the leading and/or trailing edges including forming a rounded corner between the leading edge and/or trailing edge cut-backs and unmachined portions of the airfoil between the outermost portions of the leading and/or trailing edges and the base of the airfoil.

28. A method as claimed in claim 27, further comprising the rounded corner being a semi-circular corner having an arc and radius of curvature.

29. A method as claimed in claim 24, further comprising the cut-back area having a maximum cut-back depth up to about 0.22 inches.

30. A method as claimed in claim 29, further comprising the machining away airfoil material along the leading and/or trailing edges including machining away airfoil material along only radially outermost portions of the leading and/or trailing edges extending from the outer tip towards a base of the airfoil.

31. A method as claimed in claim 30, further comprising the outermost portions of the leading and/or trailing edges having a spanwise length up to and including about 90% of a span of the airfoil from the outer tip towards the base of the airfoil.

32. A method as claimed in claim 31, further comprising the machining away airfoil material along the leading and trailing edges including forming a rounded corner between the leading edge and/or trailing edge cut-backs and unmachined portions of the airfoil between the outermost portions of the leading and/or trailing edges and the base of the airfoil.

33. A method as claimed in claim 32, further comprising the rounded corner being a semi-circular corner having an arc and radius of curvature.

34. A method as claimed in claim 24, further comprising the machining away some of the weld bead material in the weldment to obtain desired finished dimensions of at least one of the edges and/or the outer tip of the airfoil including rough machining and then final finishing of the weldment.

35. A method as claimed in claim 34, further comprising imparting the deep compressive residual stresses after the rough machining or after the final finishing of the weldment.

36. A method as claimed in claim 35, further comprising the machining away airfoil material along the leading and/or trailing edges including machining away airfoil material along only radially outermost portions of the leading and/or trailing edges extending from the outer tip towards a base of the airfoil.

37. A method as claimed in claim 36, further comprising the outermost portions of the leading and/or trailing edges having a spanwise length up to and including about 90% of a span of the airfoil from the outer tip towards the base of the airfoil.

38. A method as claimed in claim 37, further comprising the machining away airfoil material along the leading and/or trailing edges including forming a rounded corner between the leading edge and/or trailing edge cut-backs and unmachined portions of the airfoil between the outermost portions of the leading and/or trailing edges and the base of the airfoil.

39. A method as claimed in claim 38, further comprising the rounded corner being a semi-circular corner having an arc and radius of curvature.

40. A method as claimed in claim 35, further comprising the cut-back area having a maximum cut-back depth up to about 0.22 inches.

41. A method as claimed in claim 40, further comprising the machining away airfoil material along the leading and/or trailing edges including machining away airfoil material along only radially outermost portions of the leading and/or trailing edges extending from the outer tip towards a base of the airfoil.

42. A method as claimed in claim 41, further comprising the outermost portions of the leading and/or trailing edges having a spanwise length up to and including about 90% of a span of the airfoil from the outer tip towards the base of the airfoil.

43. A method as claimed in claim 42, further comprising the machining away airfoil material along the leading and trailing edges including forming a rounded corner between the leading edge and/or trailing edge cut-backs and unmachined portions of the airfoil between the outermost portions of the leading and/or trailing edges and the base of the airfoil.

44. A method as claimed in claim 43, further comprising the rounded corner being a semi-circular corner having an arc and radius of curvature.

45. A method as claimed in claim 1, further comprising setting a repaired life of a component containing the repaired gas turbine engine airfoil to substantially at or exceeding a new OEM life of the component.

46. A repaired gas turbine engine airfoil comprising:
a periphery including leading and trailing edges and a radially outer tip,
at least one cut-back area in at least a portion of the periphery,
the cut-back area being along at least a portion of at least one of the edges and/or the outer tip of the airfoil,
a weldment including successive beads of welding material in the cut-back area having a first bead on a welding surface of the airfoil along the cut-back area, and
deep compressive residual stresses imparted in a pre-stressed region extending into and encompassing the weldment and a portion of the airfoil adjacent the weldment.

47. A repaired gas turbine engine airfoil as claimed in claim 46, further comprising the cut-back area being along at least one of the leading or trailing edges in a radially outermost portion of the leading and/or trailing edges respectively and extending from the outer tip towards a base of the airfoil.

48. A repaired gas turbine engine airfoil as claimed in claim 47, further comprising the outermost portion of the leading or trailing edges having a spanwise length up to and including about 90% of a span of the airfoil from the outer tip towards the base of the airfoil.

49. A repaired gas turbine engine airfoil as claimed in claim 48, further comprising a rounded corner between the leading edge and/or trailing edge cut-backs and unmachined portions of the airfoil between the outermost portions of the leading and/or trailing edges and the base of the airfoil.

50. A repaired gas turbine engine airfoil as claimed in claim 49, further comprising the rounded corner being a semi-circular corner having an arc and radius of curvature.

51. A repaired gas turbine engine airfoil as claimed in claim 47, further comprising the cut-back area having a maximum cut-back depth up to about 0.22 inches.

52. A repaired gas turbine engine airfoil as claimed in claim 51, further comprising the cut-back area being along at least one of the leading or trailing edges in a radially outermost portion of the leading and/or trailing edges respectively and extending from the outer tip towards a base of the airfoil.

53. A repaired gas turbine engine airfoil as claimed in claim 52, further comprising the outermost portion of the leading or trailing edges having a spanwise length up to and including about 90% of a span of the airfoil from the outer tip towards the base of the airfoil.

54. A repaired gas turbine engine airfoil as claimed in claim 54, further comprising a rounded corner between the leading edge and/or trailing edge cut-backs and unmachined portions of the airfoil between the outermost portions of the leading and/or trailing edges and the base of the airfoil.

55. A repaired gas turbine engine airfoil as claimed in claim 54, further comprising the rounded corner being a semi-circular corner having an arc and radius of curvature.

56. A repaired gas turbine engine airfoil as claimed in claim 55, further comprising a repaired life of a component containing the repaired gas turbine engine airfoil to substantially at or exceeding a new OEM life of the component.

57. A repaired gas turbine engine airfoil as claimed in claim 46, the deep compressive residual stresses imparting by laser shock peening.
